(19) United States
(12) Patent Application Publication
(10) Pub. No.: US 2014/0236558 A1
(43) Pub. Date: Aug. 21, 2014

(54) Method For Partitioning Parallel Reservoir Simulations In the Presence of Wells

(71) Applicant: Serguei Maliassov, Spring, TX (US)

(72) Inventor: Serguei Maliassov, Spring, TX (US)

(21) Appl. No.: 14/110,907

(22) PCT Filed: Jan. 31, 2012
(86) PCT No.: PCT/US12/23296

§ 371 Date: Oct. 9, 2013

Related U.S. Application Data
(60) Provisional application No. 61/487,104, filed on May 17, 2011.

(51) Int. Cl. G06F 17/50

(52) U.S. Cl. CPC G06F 17/5009
USPC 703/10

(57) ABSTRACT

A method is disclosed for partitioning a grid representing a hydrocarbon reservoir. The grid is composed of a plurality of cells. A connectivity graph of nodes and edges is created. Each of the plurality of cells is represented by a node. Edges connect neighboring nodes. An edge that should not be cut by a partitioning algorithm is designated. Nodes connected by the designated edge are merged into a supernode. A first edge connecting a merged node and a non-merged node is replaced with a second edge connecting the non-merged node with the supernode. The connectivity graph is used with the supernode and the replaced edges to partition the grid. Nodes merged into supernodes are maintained in a single subdomain during partitioning.

### CROSS-REFERENCE TO RELATED APPLICATION

This application claims the benefit of U.S. Provisional Patent Application 61/487,104 filed May 17, 2011 entitled METHOD FOR PARTITIONING PARALLEL RESERVOIR SIMULATIONS IN THE PRESENCE OF WELLS, the entirety of which is incorporated by reference herein.

### FIELD OF THE INVENTION

Disclosed aspects and methodologies relate to reservoir simulation, and more particularly, to methods for three-dimensional modeling of oil or gas reservoirs on parallel computing systems.

### BACKGROUND

This section is intended to introduce various aspects of the art, which may be associated with aspects of the disclosed techniques and methodologies. References discussed in this section may be referred to hereinafter. This discussion, including the references, is believed to assist in providing a framework to facilitate a better understanding of particular aspects of the disclosure. Accordingly, this section should be read in this light and not necessarily as admissions of prior art.

The computer based simulation of oil and gas reservoirs is a tool used to predict reservoir performance and the state of surface facilities such as flow lines, compressors, and separators over time. The goal of a reservoir simulation is to understand the flow patterns of the underlying geology to optimize the production of hydrocarbons from a set of wells and surface facilities. The size and complexity of simulation models have grown proportionally with the increased availability of computing capacity as predicted by Moore's Law. Today's complex simulation models may use parallel computing systems and/or algorithms to get simulation results in a reasonable time.

A reservoir simulation is a type of computational fluid dynamics simulation where a set of partial differential equations (PDE's) which govern multi-phase, multi-component fluid flow through porous media and the connected facility network is approximated and solved. This is an iterative, time-stepping process where a particular hydrocarbon production strategy is optimized. Reservoir simulators discretize the underlying PDE's on a structured (or unstructured) grid, which represents the reservoir rock, wells, and surface facility network. State variables, such as pressure and saturation, are defined at each grid block. The choice of discretization and level of implicitness of the solution process varies, but generally speaking all choices generate a simulation workflow, a typical example of which is shown in FIG. 1 and indicated generally as reference number 20. At block 22 the workflow begins by parsing user input data that may include the problem formulation, and a geologic model is discretized into grid blocks with physical properties defined at each grid block. The physical properties may include rock (e.g. permeability) and fluid properties. After parsing user input data, the reservoir simulator steps forward in time until the desired length of time is reached. At each time step, at block 24 well management computes the current state of surface facilities and wells. At block 26 these values along with the value of state variables at each grid block are used to create the corresponding Jacobian matrix which in block 28 the linear solver uses to iteratively (block 30) generate updates to physical properties of interest (block 32), such as pressure and saturation. Once results are generated or obtained (block 34), the process repeats at the next time step (block 36).

Parallelization of the simulation process is realized by parallelizing the individual components of each time step. To achieve efficient utilization of parallel computing systems the simulation model should be distributed across the memory of the parallel computer or cluster of computers at runtime so that the computational load is evenly balanced and the amount of inter-processor communication is minimized. Therefore, partitioning is the process of assigning data to different computational units (cores, processors, central processing units, graphical processing units, etc). Each component may require a different approach to parallelization based on the numerical formulation, the actual input data, and user supplied options.

In a reservoir simulator, one of the two main types of parallelization is task-based parallelization in which a calculation is divided into sub-tasks that are run independently in parallel. For example, in well management a set of operations may be computed on a set of wells that can be performed independently of one another. Therefore, each computational unit may execute the operations independently of the other computational unit.

Grid-based parallelization is the second main type of parallelization used in a reservoir simulator and may employ Jacobian construction and property calculations. In the computational process of constructing the Jacobian, rock and fluid properties with corresponding derivatives are calculated at each grid block. This type of parallelization is used for computations that do not depend on adjacent grid blocks or require global communication for the computations. Vapor-liquid equilibrium (VLE) fluid property computations are an example of computations that may use Jacobian construction. If the VLE simulation model uses a black oil fluid characterization, then the amount of computational work required for a flash calculation is roughly proportional to the number of simulation cells due to the linear nature of the black oil VLE computations. On the other hand, if a compositional fluid model is chosen, the amount of computational work for the flash calculation within a single simulation cell depends on the cell's position in the phase state space. Hence, the amount of computational work may vary sharply from cell to cell.

A linear solver is an algorithm used to compute updates to state properties such as pressure or saturation. A linear solver requires local computations that are similar from one subdomain (which are grid blocks associated with each computational unit) to another. However, linear solvers also require global computations (which are not required for Jacobian construction) to compute updates to the state variables of interest.

Partitioning is important for all stages of a reservoir simulation, but is crucial for the efficiency of a parallel linear solver. A “good” partition has three main goals: load balance, interface minimization, and algebraic compatibility. A good load balance evenly distributes the computational work from one computational unit to another. A good partition minimizes the interface between partitions, thus minimizing the communication costs required by the algorithm using the partition. Finally, a good partition asserts good algebraic compatibility, which means that the partition should support fast convergence of the linear solver.

Partitioning can be based either on the connectivity diagram (called graph) of the grid, i.e. how grid cells are connected to each other, or the connectivity diagram of the matrix representation of the linear system. For the grid, the nodes of the graph corresponding to neighbor grid cells are connected by graph edges. For the matrix case, the diagonal elements of the matrix represent the nodes of the graph and the non-zero off-diagonal matrix elements denote a connection between corresponding nodes. In addition to the connectivity graph, partitioning algorithms may consider the weights assigned to nodes and edges of the graph. Typically, a larger edge weight implies the smaller chance that particular edge will be cut and the corresponding nodes will be partitioned into separate subdomains by the partitioning algorithm.

One factor influencing the efficiency of a parallel linear solver is preserving unknowns representing a well bore (and near well bore region) entirely in a single computational unit. When the computational domain is partitioned into subdomains, which are handled by different computational units of the parallel computing system, the boundaries of the subdomains should not partition the connections between the well nodes and the reservoir nodes. Otherwise the convergence of a linear solver may dramatically degrade.

Research articles published on the subject of graph partitioning include the following: J. D. Teresco, K. D. Devine, and J. E. Flaherty, “Partitioning and Dynamic Load Balancing for the Numerical Solution of Partial Differential Equations,” Chapter in Numerical Solution of Partial Differential Equations on Parallel Computers, 2006, pp. 55-88; and B. Hendrickson and T. Kolda, “Graph Partitioning Models for Parallel Computing,” 2000, Parallel Computing, v.26, pp. 1519-1534. Some of the partitioning techniques are implemented in software, such as: (a) METIS as described in G. Karypis and V. Kumar, “A Fast and High Quality Multilevel Scheme for Partitioning Irregular Graphs,” 1999, SIAM Journal on Scientific Computing, v.20, No. 1, pp. 359-392 or (b) Chaco, as described in B. Hendrickson and R. Leland, “An Improved Spectral Graph Partitioning Algorithm for Mapping Parallel Computations,” 1995, SIAM Journal on Scientific and Statistical Computing, v.16, No. 2, pp. 452-469 and in B. Hendrickson and R. Leland, “The Chaco User's Guide: Version 2.0,” Sandia Tech Report SAND94-2692, 1994.

Software packages that implement partitioning algorithms allow the user to assign a weight to the connection associated with each graph node. Due to algorithmic details, these weights are positive integers. As practice shows, the integer values of the weights should have a relatively short range, spanning from 1 to say 1000 or 10,000. As the range increases, the robustness of a partitioning algorithm and the quality of a created partition deteriorates. Moreover, none of the published algorithms or software includes methods for keeping certain grid blocks or physical properties of a model together in one subdomain, i.e., properly handling well connections in reservoir simulation. In other words, when using publicly available software (e.g. METIS or Chaco) it is impossible to ensure that certain graph connections will not be cut and corresponding nodes be partitioned into separate subdomains by the partitioning algorithm.

On the other hand, there are many approaches to assign weight values to edges and nodes of the graph to improve the quality of the partition. Some of them, pertinent to problems in the oil and gas industry, are described in WO 2009/075945 A1 and in U.S. Provisional Patent Application No. 61/304,056 (Now PCT/US2010/053141), both of which are commonly assigned and are incorporated by reference herein in their entirety for all purposes. These patent documents describe how to construct real weights for nodes and connections based on physical information (e.g. transmissibility, flux values, etc), and how to map those real weights to a short range of integer values. Unfortunately, that mapping does not guarantee that a partition will not have near-well cuts. What is needed is a method of partitioning a reservoir model that maintains in a single subdomain the graph connections for a reservoir feature, such as a wellbore and its associated near-wellbore region.

### SUMMARY

In one aspect, a computer-implemented method is provided for partitioning a grid representing a hydrocarbon reservoir. The grid is composed of a plurality of cells. A connectivity graph of nodes and edges is created. Each of the plurality of cells is represented by a node. Edges connect neighboring nodes. An edge that should not be cut by a partitioning algorithm is designated. Nodes connected by the designated edge are merged into a supernode. A first edge connecting a merged node and a non-merged node is replaced with a second edge connecting the non-merged node with the supernode. The connectivity graph is used with the supernode and the replaced edges to partition the grid. Nodes merged into supernodes are maintained in a single subdomain during partitioning.

In another aspect, a computer-implemented method is disclosed for partitioning a matrix composed of a plurality of elements arranged in a plurality of rows. A connectivity graph of nodes and edges is created. Each node represents one of the plurality of rows of the matrix. Each edge represents one of the plurality of elements of the matrix. Edges connect neighboring nodes. An edge that should not be cut by a partitioning algorithm is designated. Nodes connected by the designated edge are merged into a supernode. A first edge connecting a merged node and a non-merged node is replaced with a second edge connecting the non-merged node with the supernode. The connectivity graph with the supernode and the replaced edges are used to partition the matrix. Nodes merged into supernodes are maintained in a single subdomain during partitioning.

In another aspect, a method is provided for producing hydrocarbons from a subsurface formation. A connectivity graph of nodes and edges is created from a grid representing the subsurface formation. Each cell of the grid is represented by one of the nodes. The edges connect neighboring nodes. An edge that should not be cut by a partitioning algorithm is designated. Nodes connected by the designated edge are merged into a supernode. A first edge connecting a merged node and a non-merged node is replaced with a second edge connecting the non-merged node with the supernode. The grid is partitioned using the connectivity graph with the supernode and the replaced edges. Nodes merged into supernodes are maintained in a single subdomain during partitioning. A presence, location, and/or amount of hydrocarbons in the subsurface formation are predicted. Hydrocarbons are extracted from the subsurface formation based on the prediction.

In another aspect, a method is provided for partitioning a grid representing a hydrocarbon reservoir. The grid is composed of a plurality of cells. At least part of the method is implemented by a computer. A connectivity graph of nodes and edges is created. Each of the cells is represented by a node. Edges connect neighboring nodes. At least one of the nodes and edges in the connectivity graph represent a well. A weight is assigned to each of the nodes in the connectivity graph. Edge weights are assigned to edges in the connectivity graph. An edge that should not be cut by a partitioning algorithm is designated. The designated edge represents a portion of the well. Nodes connected by the designated edge are merged into a supernode. A weight assigned to the supernode is associated with the weights assigned to the merged nodes. A first edge connecting a merged node and a non-merged node is replaced with a second edge connecting the non-merged node with the supernode. An edge weight of the second edge is the same as an edge weight of the first edge when a first non-merged node associated with the first edge is only connected to one node merged into the supernode. The grid is partitioned using the connectivity graph with the supernode and the replaced edges. Nodes merged into supernodes are maintained in a single subdomain during partitioning.

In another aspect, a computer program product is provided having computer executable logic recorded on a tangible, machine readable medium. Code is provided for creating a connectivity graph of nodes and edges. Each of a plurality of cells in a grid representing a subsurface formation is represented by a node. Edges connect neighboring nodes. Code is provided for designating an edge that should not be cut by a partitioning algorithm. Code is provided for merging nodes connected by the designated edge into a supernode. Code is provided for replacing a first edge connecting a merged node and a non-merged node with a second edge connecting the non-merged node with the supernode. Code is provided for using the connectivity graph with the supernode and the replaced edges to partition the grid. Nodes merged into supernodes are maintained in a single subdomain during partitioning.

### BRIEF DESCRIPTION OF THE DRAWINGS

The foregoing and other advantages of the present invention may become apparent upon reviewing the following detailed description and drawings of non-limiting examples of embodiments in which:

FIG. 1 is a block diagram showing a known reservoir simulation method;

FIGS. 2A and 2B are flowcharts showing a method according to disclosed methodologies and techniques;

FIG. 3 is a diagram representing a simulation grid;

FIG. 4 is a diagram representing a connectivity graph derived from the simulation grid of FIG. 3;

FIG. 5 is a diagram of the connectivity graph of FIG. 4;

FIG. 6 is a diagram of a connectivity graph and the creation of supernodes;

FIG. 7 is a flowchart of a method according to disclosed methodologies and techniques;

FIG. 8 is a matrix that may be partitioned according to the disclosed methodologies and techniques;

FIG. 9 is a diagram of a connectivity graph derived from the matrix of FIG. 8;

FIG. 10 is a block diagram of a computing system;

FIG. 11 is a block diagram representing computer code;

FIG. 12 is a side elevational view of a hydrocarbon reservoir; and

FIG. 13 is a flowchart of a method according to disclosed methodologies and techniques.

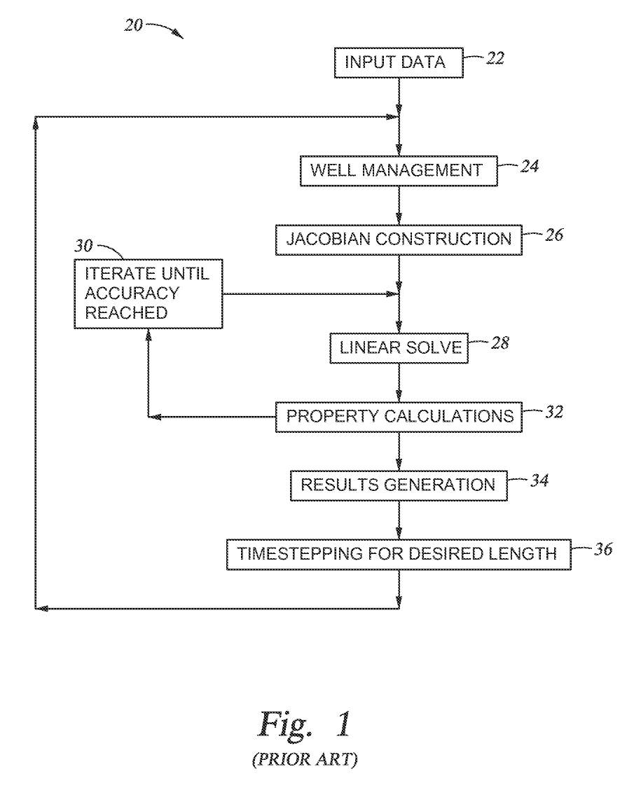

### DETAILED DESCRIPTION

To the extent the following description is specific to a particular embodiment or a particular use, this is intended to be illustrative only and is not to be construed as limiting the scope of the invention. On the contrary, it is intended to cover all alternatives, modifications, and equivalents that may be included within the spirit and scope of the invention.

Some portions of the detailed description which follows are presented in terms of procedures, steps, logic blocks, processing and other symbolic representations of operations on data bits within a memory in a computing system or a computing device. These descriptions and representations are the means used by those skilled in the data processing arts to most effectively convey the substance of their work to others skilled in the art. In this detailed description, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

Unless specifically stated otherwise as apparent from the following discussions, terms such as “creating”, “representing”, “connecting”, “designating”, “merging”, “replacing”, “using”, “partitioning”, “maintaining”, “assigning”, “predicting”, “extracting”, or the like, may refer to the action and processes of a computer system, or other electronic device, that transforms data represented as physical (electronic, magnetic, or optical) quantities within some electrical device's storage into other data similarly represented as physical quantities within the storage, or in transmission or display devices. These and similar terms are to be associated with the appropriate physical quantities and are merely convenient labels applied to these quantities.

Embodiments disclosed herein also relate to an apparatus for performing the operations herein. This apparatus may be specially constructed for the required purposes, or it may comprise a general-purpose computer selectively activated or reconfigured by a computer program or code stored in the computer. Such a computer program or code may be stored or encoded in a computer readable medium or implemented over some type of transmission medium. A computer-readable medium includes any medium or mechanism for storing or transmitting information in a form readable by a machine, such as a computer (‘machine’ and ‘computer’ are used synonymously herein). As a non-limiting example, a computer-readable medium may include a computer-readable storage medium (e.g., read only memory (“ROM”), random access memory (“RAM”), magnetic disk storage media, optical storage media, flash memory devices, etc.). A transmission medium may be twisted wire pairs, coaxial cable, optical fiber, or some other suitable transmission medium, for transmitting signals such as electrical, optical, acoustical or other form of propagated signals (e.g., carrier waves, infrared signals, digital signals, etc.).

Furthermore, modules, features, attributes, methodologies, and other aspects can be implemented as software, hardware, firmware or any combination thereof. Wherever a component of the invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the invention is not limited to implementation in any specific operating system or environment.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional blocks not shown herein. While the figures illustrate various actions occurring serially, it is to be appreciated that various actions could occur in series, substantially in parallel, and/or at substantially different points in time.

Various terms as used herein are defined below. To the extent a term used in a claim is not defined below, it should be given the broadest possible definition persons in the pertinent art have given that term as reflected in at least one printed publication or issued patent.

As used herein, “and/or” placed between a first entity and a second entity means one of (1) the first entity, (2) the second entity, and (3) the first entity and the second entity. Multiple elements listed with “and/or” should be construed in the same fashion, i.e., “one or more” of the elements so conjoined.

As used herein, “cell” is a subdivision of a grid, for example, a reservoir simulation grid. Cells may be two-dimensional or three-dimensional. Cells may be any shape, according to how the grid is defined.

As used herein, “displaying” includes a direct act that causes displaying, as well as any indirect act that facilitates displaying. Indirect acts include providing software to an end user, maintaining a website through which a user is enabled to affect a display, hyperlinking to such a website, or cooperating or partnering with an entity who performs such direct or indirect acts. Thus, a first party may operate alone or in cooperation with a third party vendor to enable the reference signal to be generated on a display device. The display device may include any device suitable for displaying the reference image, such as without limitation a CRT monitor, a LCD monitor, a plasma device, a flat panel device, or printer. The display device may include a device which has been calibrated through the use of any conventional software intended to be used in evaluating, correcting, and/or improving display results (e.g., a color monitor that has been adjusted using monitor calibration software). Rather than (or in addition to) displaying the reference image on a display device, a method, consistent with the invention, may include providing a reference image to a subject. “Providing a reference image” may include creating or distributing the reference image to the subject by physical, telephonic, or electronic delivery, providing access over a network to the reference, or creating or distributing software to the subject configured to run on the subject's workstation or computer including the reference image. In one example, the providing of the reference image could involve enabling the subject to obtain the reference image in hard copy form via a printer. For example, information, software, and/or instructions could be transmitted (e.g., electronically or physically via a data storage device or hard copy) and/or otherwise made available (e.g., via a network) in order to facilitate the subject using a printer to print a hard copy form of reference image. In such an example, the printer may be a printer which has been calibrated through the use of any conventional software intended to be used in evaluating, correcting, and/or improving printing results (e.g., a color printer that has been adjusted using color correction software).

As used herein, “exemplary” is used exclusively herein to mean “serving as an example, instance, or illustration.” Any aspect described herein as “exemplary” is not necessarily to be construed as preferred or advantageous over other aspects.

As used herein, “hydrocarbon reservoirs” include reservoirs containing any hydrocarbon substance, including for example one or more than one of any of the following: oil (often referred to as petroleum), natural gas, gas condensate, tar and bitumen.

As used herein, “hydrocarbon management” or “managing hydrocarbons” includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/or abandoning hydrocarbon resources, reviewing prior hydrocarbon management decisions, and any other hydrocarbon-related acts or activities.

As used herein, “machine-readable medium” refers to a medium that participates in directly or indirectly providing signals, instructions and/or data. A machine-readable medium may take forms, including, but not limited to, non-volatile media (e.g. ROM, disk) and volatile media (RAM). Common forms of a machine-readable medium include, but are not limited to, a floppy disk, a flexible disk, a hard disk, a magnetic tape, other magnetic medium, a CD-ROM, other optical medium, a RAM, a ROM, an EPROM, a FLASH-EPROM, EEPROM, or other memory chip or card, a memory stick, and other media from which a computer, a processor or other electronic device can read.

In the context of cell location, “neighbor” means adjacent or nearby.

As used herein, “subsurface” means beneath the top surface of any mass of land at any elevation or over a range of elevations, whether above, below or at sea level, and/or beneath the floor surface of any mass of water, whether above, below or at sea level.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional blocks not shown herein. While the figures illustrate various actions occurring serially, it is to be appreciated that various actions could occur in series, substantially in parallel, and/or at substantially different points in time.

Reservoir models may contain a large number of different types of wells (e.g. horizontal, hydraulic). According to methodologies and techniques disclosed herein, a method is disclosed that preserves in one subdomain the well, the region around the well, and the well's connections with the reservoir cells in the vicinity of perforation nodes. In other words, the methodologies and techniques disclosed herein provide a method and strategy that avoids partitioning the near well region into several different subdomains.

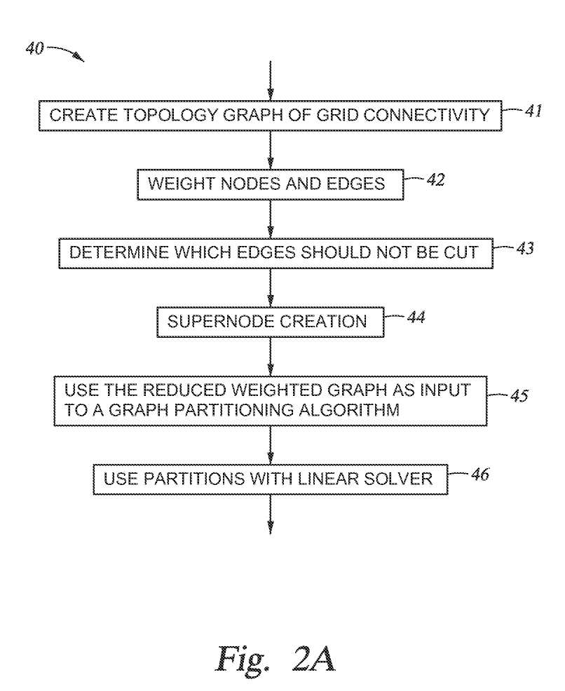

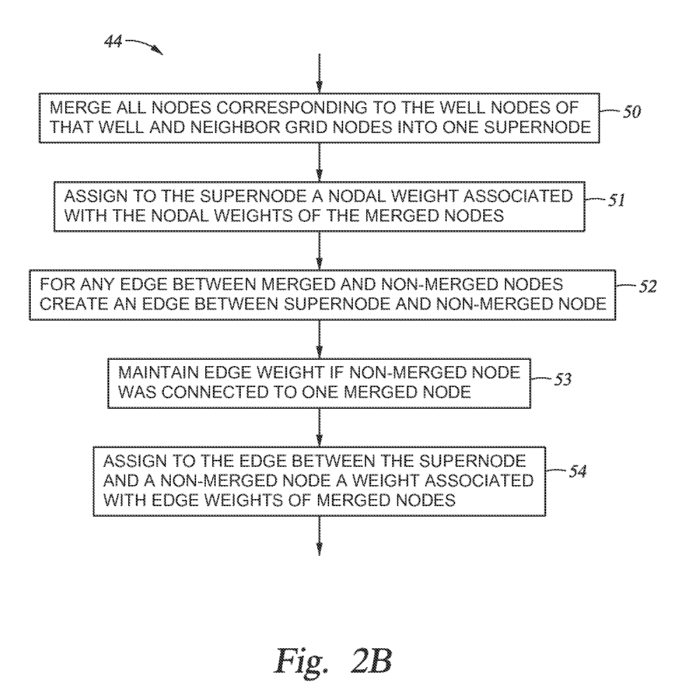

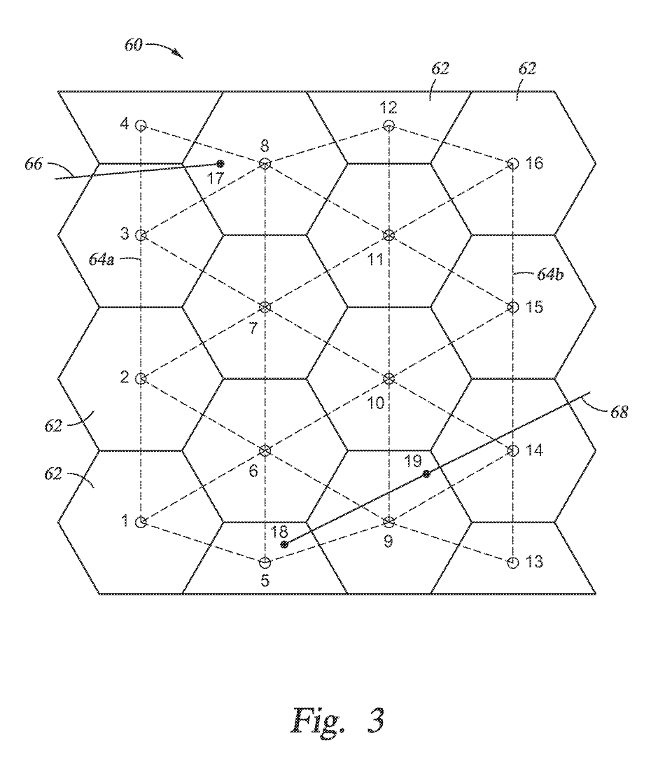

FIG. 2A is a method 40 of maintaining a well and its near-wellbore region in a single subdomain. The method may be used with a grid representing a reservoir, where the grid comprises a plurality of cells. Such a grid is depicted in FIG. 3 and indicated by reference number 60, and examples of the cells comprising the grid are indicated at 62. Each cell has an associated node, numbered 1-16 in FIG. 3. The nodes are nominally placed in the center of each cell, but the position of the node in each cell may be varied according to the desired gridding algorithm. The dotted lines connecting each node are called edges. The edges, such as edges 64a and 64b, connect the nodes and represent the connectivity between neighboring cells. A first well is represented by node 17. The near-wellbore region associated with the first well is shown by line 66, which passes through cells represented by nodes 8 and 3. A second well is represented by node 18. Node 19 represents a perforation along the second well. The near-wellbore region associated with the second well is shown by line 68, which passes through cells represented by nodes 5, 9, and 14.

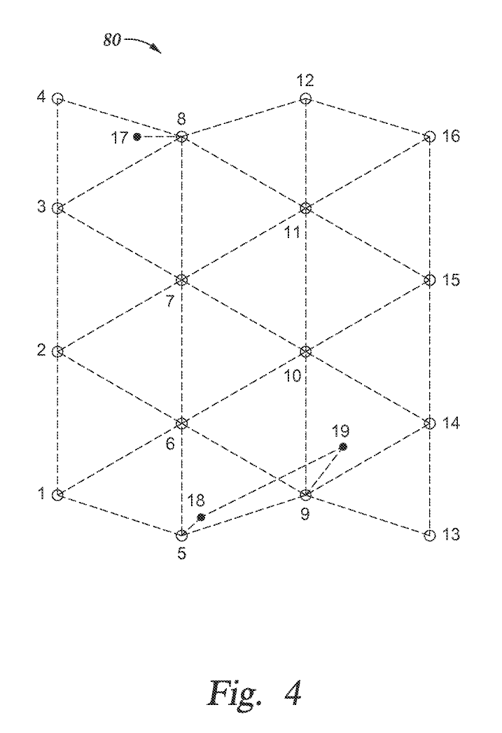

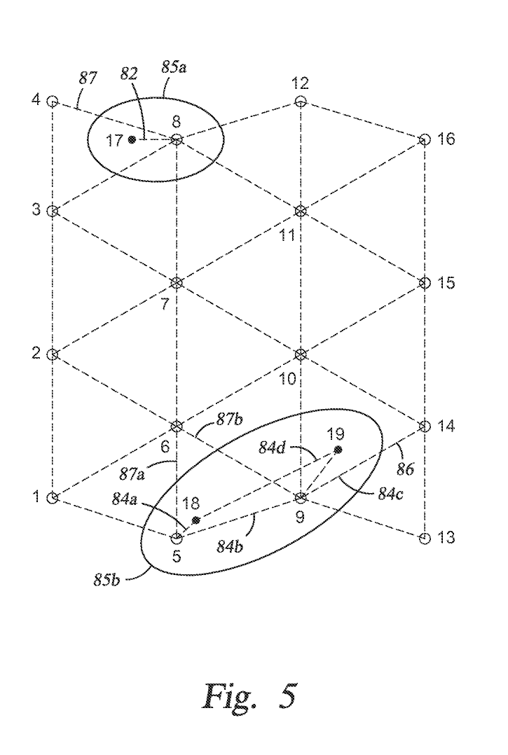

Referring to FIG. 2A, at block 41 a topology graph of the grid connectivity is created. The graph comprises the nodes and edges associated with the grid. An example of a topology graph is shown in FIG. 4 at reference number 80. At block 42 initial weights for the nodes and edges are created. For example, unit weights (equal to 1) can be assigned to the nodes and edges. Alternatively, the initial weights assigned to nodes and/or edges may be assigned according to physical information, known about each cell, such as fluid transmissibility between cells or permeability within a cell. At block 43, well connectivity information is obtained and used to determine and mark edges that should not be cut by a partitioning algorithm. An edge should not be cut when the associated nodes are located physically within the same cell. Furthermore, an edge should not be cut when the associated nodes are part of the same wellbore. For example, in FIG. 5 the edge 82 connecting nodes 8 and 17 should be maintained in a single subdomain because, as shown in FIG. 3, these nodes are contained within the same cell. Edges 84a, 84b, 84c and 84d should stay within a single subdomain because (a) nodes 5 and 18 are contained within cell 62a, (b) nodes 9 and 19 are contained within cell 62b, and (c) nodes 18 and 19 are part of the second well. The two regions where edges have been marked to be uncut are circled at 85a and 85b.

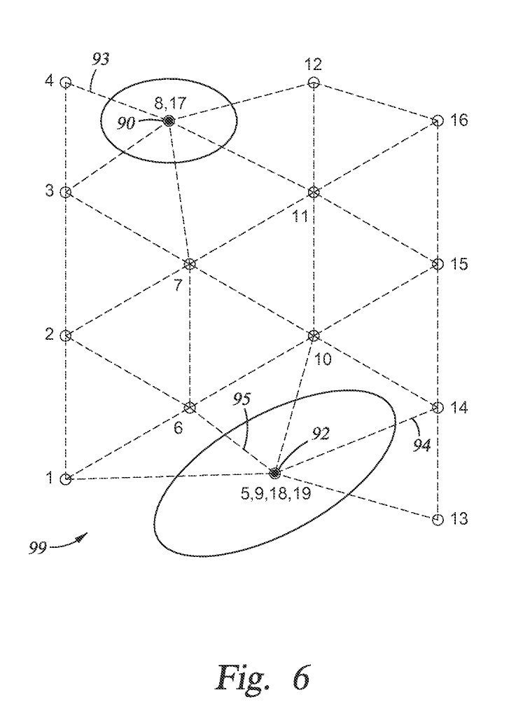

At block 44 in FIG. 2A a supernode is created for each well. The process of creating a supernode is depicted in more detail in FIG. 2B, where in block 50 the nodes associated with edges that should not be cut are merged into a supernode. As shown in FIG. 6, nodes 8 and 17 are merged into a supernode 90, and nodes 5, 9, 18 and 19 are merged into a supernode 92. The supernodes correspond to the nodes representing a well and its neighboring grid nodes. At block 51 the sum of the nodal weights of the merged nodes is assigned as the nodal weight of the supernode formed by the merged nodes. Alternatively, the nodal weight assigned to a supernode may be some function of the nodal weights of the merged nodes. As a non-limiting example of another function usable with the disclosed methodologies and techniques, the nodal weights may be the largest or highest nodal weight of the merged nodes.

For any edge between merged and non-merged nodes, at block 52 an edge between the supernode and non-merged nodes is created. For example, the edge 87 connecting node 4 and 8 (FIG. 5) is replaced by an edge 93 connecting node 4 and supernode 90 (FIG. 6). Likewise, the edges connecting node 8 with nodes 3, 7, 11 and 12, respectively, are replaced with edges connecting supernode 90 with nodes 3, 7, 11 and 12. The edges connecting nodes 5 and 9 with neighboring nodes are replaced by edges connecting supernode 92 to those neighboring nodes (FIGS. 5 and 6). At block 53 the weight of an edge modified or replaced by the creation of a supernode is maintained if the non-merged node associated with the edge was only connected to one node that was merged into the supernode. This is demonstrated in FIG. 5 by the edge 86 connecting nodes 14 and 9. As node 14 is connected to only one of the nodes (node 9) that was merged into supernode 92 (FIG. 6), the weight assigned to corresponding edge 94 is maintained. However, if at block 54 a non-merged node is connected to two or more nodes that were merged into a supernode, then the edge connecting that non-merged node to the supernode is assigned a weight equal to sum (or some other function) of the weights of the edges that connected the non-merged node to the merged nodes. For example, in FIG. 5 edges 87a and 87b connect node 6 to nodes 5 and 9, respectively. When supernode 92 is created (FIG. 6), the edge 95 connecting node 6 to supernode 92 is assigned a weight equal to the sum (or some other function) of the weights of edges 87a and 87b. As a non-limiting example of another function usable with the disclosed methodologies and techniques, the edge 95 may be assigned a weight equal to the largest or highest weight assigned to edges 87a and 87b.

The results of the method thus far are shown in FIG. 6, which depicts a reduced weighted graph 99. The supernodes represent nodes and edges that should stay together when the graph is partitioned for parallel processing algorithms. Returning to FIG. 2A, at block 45 the reduced weighted graph shown in FIG. 6 is used as an input to a graph partitioning algorithm. Any partitioning algorithm may be used. Since all nodes belonging to one supernode will be placed in the same subdomain, method 40 ensures the partitioning algorithm will not partition wells—or the associated near well region—into different subdomains. At block 46 partitions created by the partitioning algorithm are used as a domain mapping for the assignment of grid blocks to processors for a linear solver.

Method 40 can be applied once per simulation to create a static partition. Alternatively, method 40 can be used to create a dynamic partition by applying the algorithm at different stages of the simulation using changing data (e.g. transmissibility or total fluid velocity) to define the weights of the graph or matrix at different times.

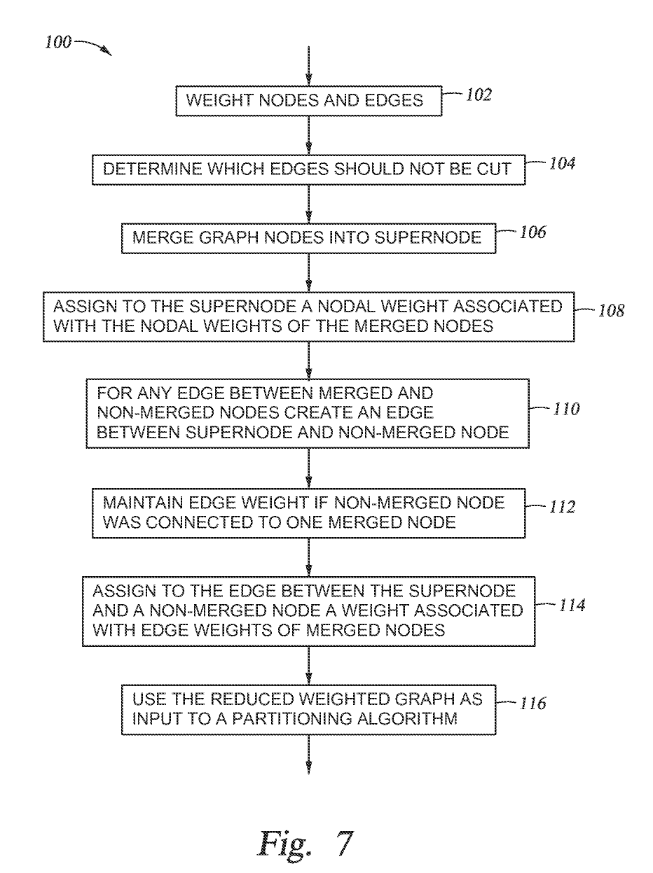

FIG. 7 shows another method 100 according to disclosed methodologies and techniques. At block 102 initial weights for the graph nodes and graph connections are created. For example, unit weights (equal to 1) may be assigned to the nodes and/or edges. At block 104 edges are marked that should not be cut by a partitioning algorithm. At block 106 graph nodes connected by any marked edge are merged into a supernode. At block 108 the supernode is assigned a weight equal to the sum (or other function) of the nodal weights of the merged nodes. At block 110, for any edge between a merged node and a non-merged node, an edge between the supernode and the non-merged node is created. At block 112 edge weights for unique connections (one non-merged node to one merged node) are maintained. If at block 114 a non-merged node is connected to two or more nodes that were merged into a supernode, then the edge connecting that non-merged node to the supernode is assigned a weight equal to sum (or some other function) of the weights of the edges that connected the non-merged node to the merged nodes. At block 116 the reduced weighted graph created or generated by the method 100 is used as an input to a partitioning algorithm.

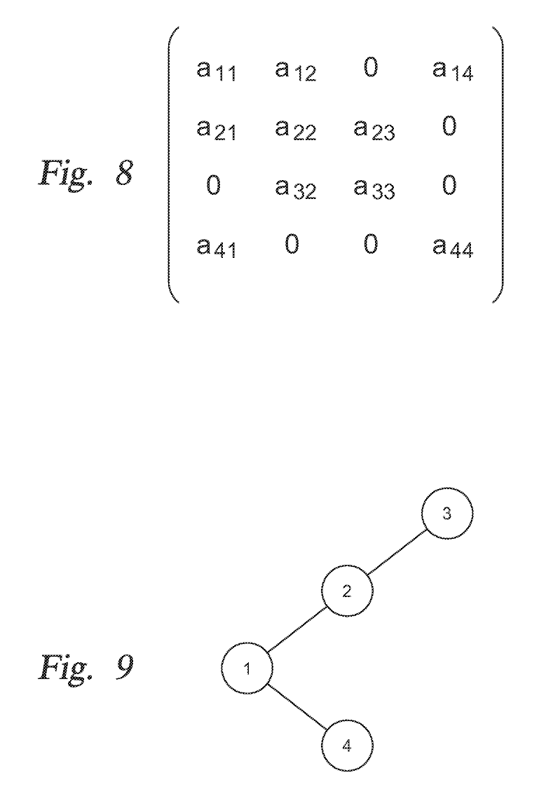

The methodologies and techniques described herein have been presented in the context of maintaining wells and associated near well regions in the same subdomain when a reservoir model is partitioned for parallel processing purposes. However, the described methodologies and techniques may be used to maintain any desired portions of a reservoir model in a single subdomain. Furthermore, the methodologies and techniques described herein may be applied to partition a matrix equation. FIG. 8 is an example 4×4 matrix 120. A corresponding connectivity graph is created, as shown at 130 in FIG. 9, where each node 1-4 corresponds to a single equation, or row, in the matrix. Each diagonal element of the matrix represents a node and each non-diagonal non-zero element of the matrix represents a weight of an edge connecting corresponding nodes. For example, element a₃₁ of matrix 120 represents the edge weight of the connection between node 3 and node 1. The connectivity graph 130 may then be used to identify the nodes (and their corresponding equations) that must not be partitioned during a solving operation. As in method 100, the corresponding edges to not be cut are marked, and the remainder of method 100 is applied to partition the connectivity graph. Because the matrix equations correspond to the nodes, the matrix 120 can be partitioned and solved using the methodologies described herein.

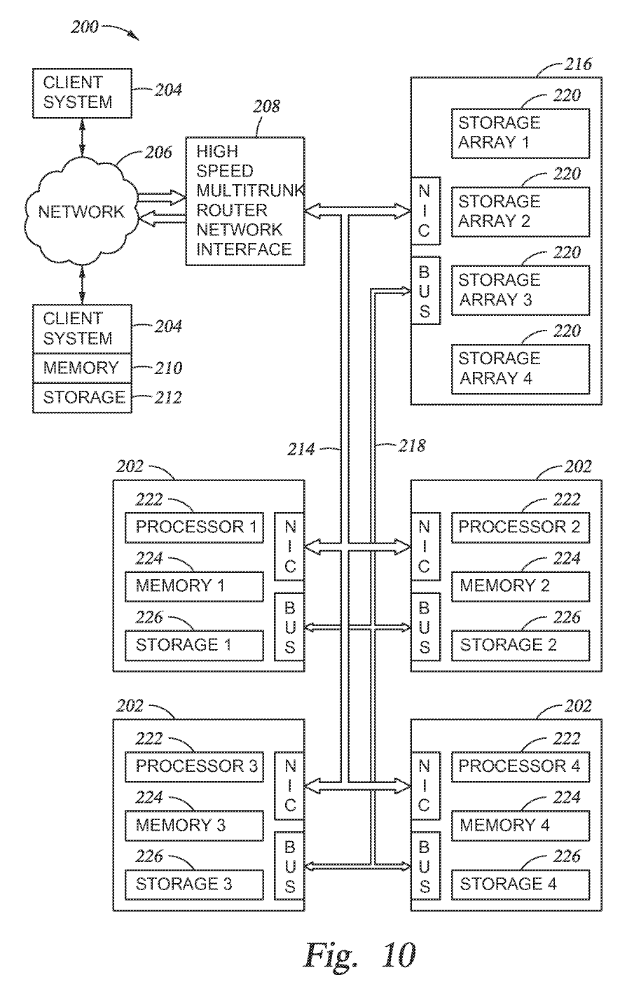

FIG. 10 is a block diagram of a cluster computing system 200 that may be used with the disclosed methodologies and techniques. Computing system 200 has four computing units 202, each of which may perform calculations for part of a simulation model. However, one of ordinary skill in the art will recognize that the present techniques are not limited to this configuration, as any number of computing configurations may be selected. For example, a small simulation model may be run on a single computing unit 202, such as a workstation, while a large simulation model may be run on a computing system 200 having 10, 100, 1000, or even more computing units 202. Each of the computing units 202 runs the simulation for a single subdomain. However, allocation of the computing units 202 may be performed in any number of ways. For example, multiple subdomains may be allocated to a single computing unit 202 or multiple computing units 202 may be assigned to a single subdomain, depending on the computational load on each computing unit 202.

Computing system 200 may be accessed from one or more client systems 204 over a network 206, for example, through a high speed network interface 208. Each of client systems 204 may have tangible, computer readable memory 210 for the storage of operating code and programs, including random access memory (RAM) and read only memory (ROM). The operating code and programs may include the code used to implement all or portions of the methods discussed herein. Client systems 204 can also have other tangible, computer readable media, such as storage systems 212. The storage systems 212 may include one or more hard drives, one or more optical drives, one or more flash drives, any combinations of these units, or any other suitable storage device. The storage systems 212 may be used for the storage of code, models, data, and other information used for implementing the methods described herein.

The high speed network interface 208 may be coupled to one or more communications busses in the computing system 200, such as a communications bus 214. The communication bus 214 may be used to communicate instructions and data from the high speed network interface 208 to a cluster storage 216 and to each of the computing units 202. Communications bus 214 may also be used for communications among computing units 202 and the storage array 216. In addition to the communications bus 214 a high speed bus 218 can be present to increase the communications rate between computing units 202 and/or the cluster storage 216.

The cluster storage 216 can have one or more tangible, computer readable media devices, such as storage arrays 220 for the storage of data, visual representations, results, code, or other information, for example, concerning the implementation of and results from the methods described herein. Storage arrays 220 may include any combination of hard drives, optical drives, flash drives, holographic storage arrays, or any other suitable devices.

Each of the computing units 202 can have a processor 222 and associated local tangible, computer readable media, such as memory 224 and storage 226. The memory 224 may include ROM and/or RAM used to store code, for example, used to direct the processor 222 to implement the methods described herein. The storage 226 may include one or more hard drives, one or more optical drives, one or more flash drives, or any combinations thereof. The storage 226 may be used to provide storage for intermediate results, data, images, or code associated with operations, including code used to implement the methods described herein.

The present methodologies and techniques are not limited to the architecture of the computer system 200 illustrated in FIG. 10. For example, any suitable processor-based device may be used to implement all or a portion of the disclosed methodologies and techniques, including without limitation personal computers, laptop computers, computer workstations, GPUs, mobile devices, and multi-processor servers or workstations with (or without) shared memory. Moreover, the disclosed methodologies and techniques may be implemented on application specific integrated circuits (ASICs) or very large scale integrated (VLSI) circuits. In fact, persons of ordinary skill in the art may use any number of suitable structures capable of executing logical operations.

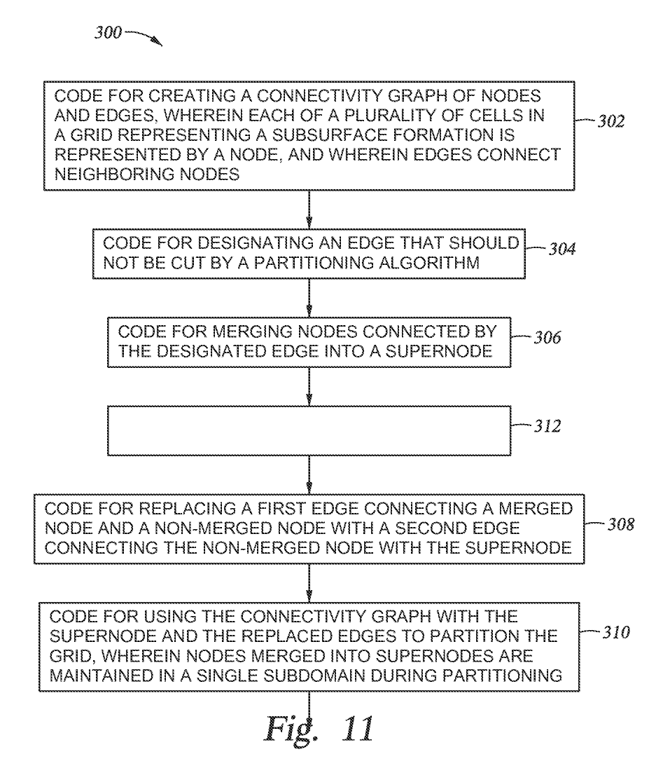

FIG. 11 shows a representation of machine-readable logic or code 300 that may be used or executed with a computing system such as computing system 200. At block 302 code is provided for creating a connectivity graph of nodes and edges, wherein each of a plurality of cells in a grid representing a subsurface formation is represented by a node, and wherein edges connect neighboring nodes. At block 304 code is provided for designating an edge that should not be cut by a partitioning algorithm. At block 306 code is provided for merging nodes connected by the designated edge into a supernode. At block 308 code is provided for replacing a first edge connecting a merged node and a non-merged node with a second edge connecting the non-merged node with the supernode. At block 310 code is provided for using the connectivity graph with the supernode and the replaced edges to partition the grid, wherein nodes merged into supernodes are maintained in a single subdomain during partitioning. Code effectuating or executing other features of the disclosed aspects and methodologies may be provided as well. This additional code is represented in FIG. 11 as block 312, and may be placed at any location within code 300 according to computer code programming techniques.

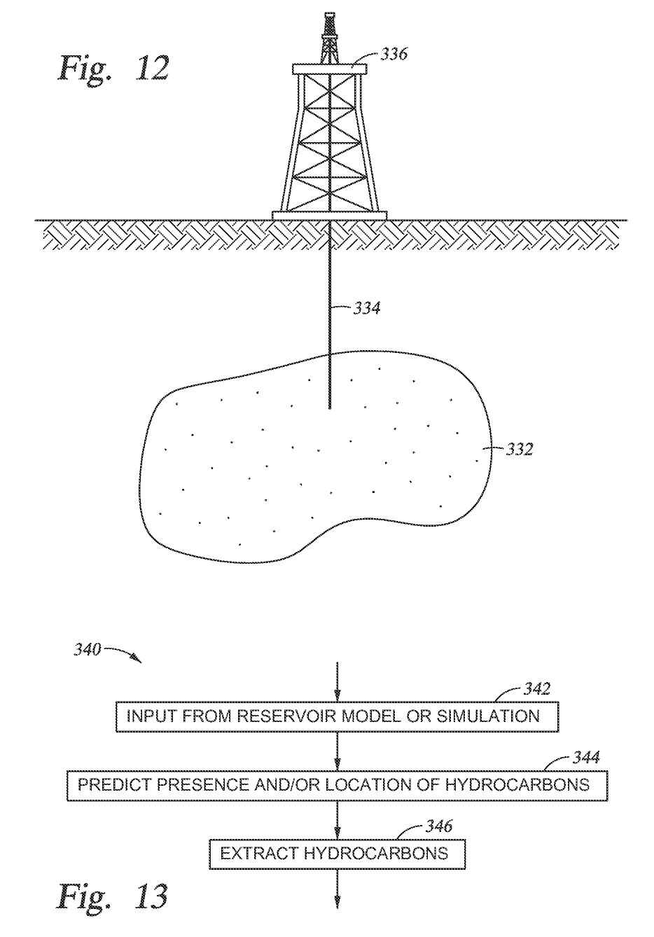

Aspects disclosed herein may be used to perform hydrocarbon management activities such as extracting hydrocarbons from a subsurface formation, region, or reservoir, which is indicated by reference number 332 in FIG. 12. A method 340 of extracting hydrocarbons from subsurface reservoir 332 is shown in FIG. 13. At block 342 inputs are received from a numerical model, geologic model, or flow simulation of the subsurface region, where the model or simulation has been run or improved using the methods and aspects disclosed herein. At block 344 the presence and/or location of hydrocarbons in the subsurface region is predicted. At block 346 hydrocarbon extraction is conducted to remove hydrocarbons from the subsurface region, which may be accomplished by drilling a well 334 using oil drilling equipment 336 (FIG. 12). Other hydrocarbon management activities may be performed according to known principles.

Illustrative, non-exclusive examples of methods and products according to the present disclosure are presented in the following non-enumerated paragraphs. It is within the scope of the present disclosure that an individual step of a method recited herein, including in the following enumerated paragraphs, may additionally or alternatively be referred to as a “step for” performing the recited action.

A. A computer-implemented method of partitioning a grid representing a hydrocarbon reservoir, the grid composed of a plurality of cells, the method comprising:

creating a connectivity graph of nodes and edges, wherein each of the plurality of cells is represented by a node, and wherein edges connect neighboring nodes;

designating an edge that should not be cut by a partitioning algorithm;

merging nodes connected by the designated edge into a supernode;

replacing a first edge connecting a merged node and a non-merged node with a second edge connecting the non-merged node with the supernode; and

using the connectivity graph with the supernode and the replaced edges to partition the grid, wherein nodes merged into supernodes are maintained in a single subdomain during partitioning.

A1. The method of paragraph A, further comprising:

assigning a weight to nodes in the connectivity graph; and

assigning to the supernode a weight associated with weights assigned to the nodes merged to form the supernode.

A2. The method of any of paragraphs A-A1, wherein the weight assigned to the supernode is a function of the weights assigned to the nodes merged to form the supernode.

A3. The method of any of paragraphs A-A2, wherein the function is the sum of the weights assigned to the nodes merged to form the supernode.

A4. The method of any of paragraphs A-A3, further comprising:

assigning edge weights to edges in the connectivity graph, wherein an edge weight of the second edge is the same as an edge weight of the first edge when a first non-merged node associated with the first edge is only connected to one node merged into the supernode.

A5. The method of any of paragraphs A-A4, wherein the merged node is a first merged node, and further including

a second merged node, and

a third edge connecting the non-merged node to the second merged node, wherein replacing the first edge with a second edge further includes replacing the first and third edges with the second edges, the method further comprising:

assigning an edge weight to the second edge that is associated with the edge weight of the first edge and an edge weight of the third edge.

A6. The method of any of paragraphs A-A5, wherein the edge weight assigned to the second edge is a function of the weights assigned to the first edge and the third edge.

A7. The method of any of paragraphs A-A6, wherein the function is the sum of the weights assigned to the first edge and the third edge.

A8. The method of any of paragraphs A-A7, wherein at least one of the nodes and edges in the connectivity graph represent a well, and wherein the designated edge represents a portion of the well.

A9. The method of any of paragraphs A-A8, wherein at least one of the nodes and edges in the connectivity graph represent a near-wellbore region, and wherein the designated edge represents a portion of the near-wellbore region.

A10. The method of any of paragraphs A-A9, further comprising:

using the partitioned grid, predicting at least one of a presence, location, and amount of hydrocarbons in the subsurface reservoir; and

extracting hydrocarbons from the subsurface reservoir based on said prediction.

B. A computer-implemented method of partitioning a matrix, the matrix composed of a plurality of elements arranged in a plurality of rows, the method comprising:

creating a connectivity graph of nodes and edges, wherein each node represents one of the plurality of rows of the matrix, each edge represents one of the plurality of elements of the matrix, and wherein edges connect neighboring nodes;

designating an edge that should not be cut by a partitioning algorithm;

merging nodes connected by the designated edge into a supernode;

replacing a first edge connecting a merged node and a non-merged node with a second edge connecting the non-merged node with the supernode; and

using the connectivity graph with the supernode and the replaced edges to partition the matrix, wherein nodes merged into supernodes are maintained in a single subdomain during partitioning.

B1. The method of paragraph B, further comprising:

assigning a weight to nodes in the connectivity graph;

assigning edge weights to edges in the connectivity graph; and

assigning to the supernode a weight associated with weights assigned to the nodes merged to form the supernode;

wherein an edge weight of the second edge is the same as an edge weight of the first edge when a first non-merged node associated with the first edge is only connected to one node merged into the supernode.

B2. The method of any of paragraphs B-B1, wherein at least one of the nodes and edges in the connectivity graph represent a near-wellbore region, and wherein the designated edge represents a portion of the near-wellbore region.

B3. The method of any of paragraphs B-B2, further comprising:

using the matrix to predict at least one of a presence, location, and amount of hydrocarbons in a subsurface reservoir; and

extracting hydrocarbons from the subsurface reservoir based on said prediction.

C. A method of producing hydrocarbons from a subsurface formation, comprising:

from a grid representing the subsurface formation, creating a connectivity graph of nodes and edges, wherein each cell of the grid is represented by one of the nodes, and wherein the edges connect neighboring nodes;

designating an edge that should not be cut by a partitioning algorithm;

merging nodes connected by the designated edge into a supernode;

replacing a first edge connecting a merged node and a non-merged node with a second edge connecting the non-merged node with the supernode;

using the connectivity graph with the supernode and the replaced edges to partition the grid, wherein nodes merged into supernodes are maintained in a single subdomain during partitioning;

predicting at least one of a presence, location, and amount of hydrocarbons in the subsurface formation; and

extracting hydrocarbons from the subsurface formation based on said prediction.

C1. The method of paragraph C, further comprising:

assigning edge weights to edges in the connectivity graph;

wherein an edge weight of the second edge is the same as an edge weight of the first edge when a first non-merged node associated with the first edge is only connected to one node merged into the supernode.

C2. The method of any of paragraphs C-C1, wherein the merged node is a first merged node, and further including

a second merged node, and

a third edge connecting the non-merged node to the second merged node, wherein replacing the first edge with a second edge further includes replacing the first and third edges with the second edges, the method further comprising:

assigning an edge weight to the second edge that is associated with the edge weight of the first edge and an edge weight of the third edge.

D. A method of partitioning a grid representing a hydrocarbon reservoir, the grid composed of a plurality of cells, at least part of the method being implemented by a computer, the method comprising:

creating a connectivity graph of nodes and edges, wherein each of the plurality of cells is represented by a node, and wherein edges connect neighboring nodes, and further wherein at least one of the nodes and edges in the connectivity graph represent a well;

assigning a weight to each of the nodes in the connectivity graph;

assigning edge weights to edges in the connectivity graph;

designating an edge that should not be cut by a partitioning algorithm, wherein the designated edge represents a portion of the well;

merging nodes connected by the designated edge into a supernode;

assigning to the supernode a weight associated with the weights assigned to the merged nodes;

replacing a first edge connecting a merged node and a non-merged node with a second edge connecting the non-merged node with the supernode, wherein an edge weight of the second edge is the same as an edge weight of the first edge when a first non-merged node associated with the first edge is only connected to one node merged into the supernode; and

using the connectivity graph with the supernode and the replaced edges to partition the grid, wherein nodes merged into supernodes are maintained in a single subdomain during partitioning.

E. A computer program product having computer executable logic recorded on a tangible, machine-readable medium, comprising:

code for creating a connectivity graph of nodes and edges, wherein each of a plurality of cells in a grid representing a subsurface formation is represented by a node, and wherein edges connect neighboring nodes;

code for designating an edge that should not be cut by a partitioning algorithm;

code for merging nodes connected by the designated edge into a supernode;

code for replacing a first edge connecting a merged node and a non-merged node with a second edge connecting the non-merged node with the supernode; and

code for using the connectivity graph with the supernode and the replaced edges to partition the grid, wherein nodes merged into supernodes are maintained in a single subdomain during partitioning.

The disclosed aspects, methodologies and techniques may be susceptible to various modifications, and alternative forms and have been shown only by way of example. The disclosed aspects, methodologies and techniques are not intended to be limited to the specifics of what is disclosed herein, but include all alternatives, modifications, and equivalents falling within the spirit and scope of the appended claims.

What is claimed is:

1. A computer-implemented method of partitioning a grid representing a hydrocarbon reservoir, the grid composed of a plurality of cells, the method comprising:
creating a connectivity graph of nodes and edges, wherein each of the plurality of cells is represented by a node, and wherein edges connect neighboring nodes;
designating an edge that should not be cut by a partitioning algorithm;
merging nodes connected by the designated edge into a supernode;
replacing a first edge connecting a merged node and a non-merged node with a second edge connecting the non-merged node with the supernode; and
using the connectivity graph with the supernode and the replaced edges to partition the grid, wherein nodes merged into supernodes are maintained in a single subdomain during partitioning.

2. The method of claim 1, further comprising:
assigning a weight to nodes in the connectivity graph; and
assigning to the supernode a weight associated with weights assigned to the nodes merged to form the supernode.

3. The method of claim 2, wherein the weight assigned to the supernode is a function of the weights assigned to the nodes merged to form the supernode.

4. The method of claim 3, wherein the function is the sum of the weights assigned to the nodes merged to form the supernode.

5. The method of claim 1, further comprising:
assigning edge weights to edges in the connectivity graph, wherein an edge weight of the second edge is the same as an edge weight of the first edge when a first non-merged node associated with the first edge is only connected to one node merged into the supernode.

6. The method of claim 5, wherein the merged node is a first merged node, and further including
a second merged node, and
a third edge connecting the non-merged node to the second merged node, wherein replacing the first edge with a second edge further includes replacing the first and third edges with the second edges, the method further comprising:
assigning an edge weight to the second edge that is associated with the edge weight of the first edge and an edge weight of the third edge.

7. The method of claim 6, wherein the edge weight assigned to the second edge is a function of the weights assigned to the first edge and the third edge.

8. The method of claim 7, wherein the function is the sum of the weights assigned to the first edge and the third edge.

9. The method of claim 1, wherein at least one of the nodes and edges in the connectivity graph represent a well, and wherein the designated edge represents a portion of the well.

10. The method of claim 1, wherein at least one of the nodes and edges in the connectivity graph represent a near-wellbore region, and wherein the designated edge represents a portion of the near-wellbore region.

11. The method of claim 1, further comprising:
using the partitioned grid, predicting at least one of a presence, location, and amount of hydrocarbons in the subsurface reservoir; and
extracting hydrocarbons from the subsurface reservoir based on said prediction.

12. A computer-implemented method of partitioning a matrix, the matrix composed of a plurality of elements arranged in a plurality of rows, the method comprising:
creating a connectivity graph of nodes and edges, wherein each node represents one of the plurality of rows of the matrix, each edge represents one of the plurality of elements of the matrix, and wherein edges connect neighboring nodes;
designating an edge that should not be cut by a partitioning algorithm;
merging nodes connected by the designated edge into a supernode;
replacing a first edge connecting a merged node and a non-merged node with a second edge connecting the non-merged node with the supernode; and
using the connectivity graph with the supernode and the replaced edges to partition the matrix, wherein nodes merged into supernodes are maintained in a single subdomain during partitioning.

13. The method of claim 12, further comprising:
assigning a weight to nodes in the connectivity graph;
assigning edge weights to edges in the connectivity graph; and
assigning to the supernode a weight associated with weights assigned to the nodes merged to form the supernode;
wherein an edge weight of the second edge is the same as an edge weight of the first edge when a first non-merged node associated with the first edge is only connected to one node merged into the supernode.

14. The method of claim 12, wherein at least one of the nodes and edges in the connectivity graph represent a near-wellbore region, and wherein the designated edge represents a portion of the near-wellbore region.

15. The method of claim 12, further comprising:
using the matrix to predict at least one of a presence, location, and amount of hydrocarbons in a subsurface reservoir; and
extracting hydrocarbons from the subsurface reservoir based on said prediction.

16. A method of producing hydrocarbons from a subsurface formation, comprising:
from a grid representing the subsurface formation, creating a connectivity graph of nodes and edges, wherein each cell of the grid is represented by one of the nodes, and wherein the edges connect neighboring nodes;
designating an edge that should not be cut by a partitioning algorithm;
merging nodes connected by the designated edge into a supernode;
replacing a first edge connecting a merged node and a non-merged node with a second edge connecting the non-merged node with the supernode;
using the connectivity graph with the supernode and the replaced edges to partition the grid, wherein nodes merged into supernodes are maintained in a single subdomain during partitioning;
predicting at least one of a presence, location, and amount of hydrocarbons in the subsurface formation; and
extracting hydrocarbons from the subsurface formation based on said prediction.

17. The method of claim 16, further comprising:
assigning edge weights to edges in the connectivity graph;
wherein an edge weight of the second edge is the same as an edge weight of the first edge when a first non-merged node associated with the first edge is only connected to one node merged into the supernode.

18. The method of claim 17, wherein the merged node is a first merged node, and further including
a second merged node, and
a third edge connecting the non-merged node to the second merged node, wherein replacing the first edge with a second edge further includes replacing the first and third edges with the second edges, the method further comprising:
assigning an edge weight to the second edge that is associated with the edge weight of the first edge and an edge weight of the third edge.

19. A method of partitioning a grid representing a hydrocarbon reservoir, the grid composed of a plurality of cells, at least part of the method being implemented by a computer, the method comprising:
creating a connectivity graph of nodes and edges, wherein each of the plurality of cells is represented by a node, and wherein edges connect neighboring nodes, and further wherein at least one of the nodes and edges in the connectivity graph represent a well;
assigning a weight to each of the nodes in the connectivity graph;
assigning edge weights to edges in the connectivity graph;
designating an edge that should not be cut by a partitioning algorithm, wherein the designated edge represents a portion of the well;
merging nodes connected by the designated edge into a supernode;
assigning to the supernode a weight associated with the weights assigned to the merged nodes;
replacing a first edge connecting a merged node and a non-merged node with a second edge connecting the non-merged node with the supernode, wherein an edge weight of the second edge is the same as an edge weight of the first edge when a first non-merged node associated with the first edge is only connected to one node merged into the supernode; and
using the connectivity graph with the supernode and the replaced edges to partition the grid, wherein nodes merged into supernodes are maintained in a single subdomain during partitioning.

20. A computer program product having computer executable logic recorded on a tangible, machine-readable medium, comprising:
code for creating a connectivity graph of nodes and edges, wherein each of a plurality of cells in a grid representing a subsurface formation is represented by a node, and wherein edges connect neighboring nodes;
code for designating an edge that should not be cut by a partitioning algorithm;
code for merging nodes connected by the designated edge into a supernode;
code for replacing a first edge connecting a merged node and a non-merged node with a second edge connecting the non-merged node with the supernode; and
code for using the connectivity graph with the supernode and the replaced edges to partition the grid, wherein nodes merged into supernodes are maintained in a single subdomain during partitioning.
